(19) United States
(12) Patent Application Publication
(10) Pub. No.: US 2024/0308185 A1
(43) Pub. Date: Sep. 19, 2024

(54) FIRE-RESISTANT GLAZING

(71) Applicant: Pilkington Group Limited, Lathom (GB)

(72) Inventors: Andreas POERSCH, Gelsenkirchen (DE); Guido SIEBERT, Gelsenkirchen (DE)

(73) Assignee: Pilkington Group Limited, Lathom (GB)

(21) Appl. No.: 18/572,911

(22) PCT Filed: Jun. 28, 2022
(86) PCT No.: PCT/GB2022/051652

§ 371 Date: Dec. 21, 2023

(30) Foreign Application Priority Data
Jun. 30, 2021 (GB) 2109410.7

(51) Int. Cl. B32B 17/10; B32B 3/08; C09J 5/00; C09J 123/22; C09J 181/04; E06B 5/16

(52) U.S. Cl. CPC B32B 17/10311; B32B 3/085; B32B 17/10036; B32B 17/10302; B32B 17/10807; C09J 5/00; C09J 123/22; C09J 181/04; E06B 5/165; B32B 2250/40; B32B 2255/26; B32B 2310/0418; B32B 2419/00; B32B 2605/00; C09J 2400/146; C09J 2423/00; C09J 2481/00

(57) ABSTRACT

The invention provides a fire-resistant glazing that is less susceptible to failure, a method of manufacturing a fire-resistant glazing, and the use of a fire-resistant glazing, the fire-resistant glazing including a glazing edge wherein at least one area of the glazing edge comprises a weakened primary sealant portion and/or a weakened secondary sealant portion.

This invention relates to a fire-resistant glazing, a method of manufacturing said fire-resistant glazing, and to the use thereof.

Fire-resistant glazings generally comprise at least two transparent panes and at least one fire-resistant interlayer disposed between the two transparent panes. The transparent panes are commonly glass panes, although other transparent materials such as polycarbonates may be used. In many countries, regulations exist specifying the fire resistance needed for use in particular locations. Generally, these regulations specify a minimum time for which the glazing must form a barrier to the propagation of fire and/or smoke when the glazing is exposed to a fire.

A common fire-resistant interlayer is an intumescent layer. If the intumescent layer is heated to an activation temperature the intumescent layer will intumesce, forming a highly insulating mass. Such intumescence is associated with expansion and foaming of the intumescent layer, which often has a cooling effect. In addition, many intumescent layers contain water, and will release water as vapour, also providing a cooling effect that reduces the conduction of heat through the fire-resistant glazing.

Intumescent layers for fire-resistant glazings may be formed by a “cast-in-place” method or a “pour-and-dry” method.

Intumescent layers formed by the “cast-in-place” method are usually formed by pouring a solution of an intumescent layer precursor between two glass panes. In order for the intumescent layer precursor to be poured and retained between the glass panes, an edge seal is required to form a cavity.

For example, U.S. Pat. No. 5,565,273 A discloses a method for the production of a transparent heat protection element using a hydrous alkali silicate, comprising introducing a pourable composition into a mould cavity between two transparent carrier elements and allowing the composition to cure to form a solid polysilicate layer.

In contrast, intumescent layers formed by a pour-and-dry method may be formed directly on a glass pane to be incorporated in a fire-resistant glazing unit.

For example, EP 2557141 B1 discloses a fire protection component which is formed in a planar manner and which is connected to at least one space-bounding surface component.

Alternatively, intumescent layers formed by a “pour-and-dry” method may be formed on a temporary substrate, and then separated from the temporary substrate and applied as a sheet to a glass pane to be incorporated in the fire-resistant glazing unit.

For example, US 2005016742 A1 discloses a process for the production of a clear flexible film comprising an alkali metal silicate waterglass which comprises spreading a waterglass solution upon the surface of a flexible backing material, drying said solution to form a clear film and separating said film from said backing material.

Known fire-resistant glazings rely on the intumescent layer remaining in contact with the glass pane which is orientated towards a heat source in the event of a fire. If the intumescent layer becomes separated from the glass pane orientated towards the heat source, a gas layer may form between the glass pane and the intumescent layer. This gas layer insulates the intumescent layer from the heat source, preventing the intumescent layer from attaining the required activation temperature for intumescence. As a result, the intumescent layer does not absorb heat from the glass pane orientated toward the heat source effectively, and the glass pane rapidly increases in temperature. With continued heating the gas layer increases in temperature, and expands, causing the fire-resistant glazing unit to vent the gas layer. The venting of the gas layer may be via destruction of the glass pane orientated toward the heat source, leading to a drastic decrease in the efficacy of the fire-resistant glazing. Alternatively, the venting of the gas layer may be via the edge of glazing. In some cases this may cause significant damage to the glazing frame and other structural elements associated with the glazing. If sufficient damage is done to the glazing frame it may crack or deform, allowing the passage of some and/or heat around the fire-resistant glazing and again greatly reducing its effectiveness.

Following venting of the gas layer, the intumescent layer will either contact the heated glass pane, or be directly exposed to the heat source. This causes the intumescent layer to rapidly increase in temperature, causing the formation of an inhomogeneous foam structure and thereby lead to reduced fire performance.

Previous attempts to prevent failure of fire-resistant glazings in this manner have focused on weakening the glass panes, to allow the glass pane orientated towards the fire to fail at a low gas pressure and therefore a low temperature.

For example, US 2013196091 A1 discloses a fire protection glazing comprising: at least two transparent support elements and an intermediate layer arranged between the support elements, wherein at least one of the support elements is a glass plate provided with at least one defined point of local weakening.

However, a fire-resistant glazing comprising weakened glass panes may not be acceptable during normal use, due to a lack of impact resistance. In addition, such glazings with weakened glass panes will cause the interlayer to be exposed directly to fire following breakage of the weakened glass pane, which may cause inhomogeneous foaming behaviour. Furthermore, a glazing comprising weakened glass panes may not retain the intumescent layer following breakage of the weakened glass pane.

GB 2571087 B discloses a glazing unit comprising a fire resistant interlayer and a seal configured to breach in the event of increased pressure between the first and second glass panes.

It is therefore an object of the present invention is to overcome the aforementioned disadvantages apparent in the prior art. In particular, the present invention aims to provide a fire-resistant glazing which is less-susceptible to failure due to too high an internal pressure, and that reduces the conduction of heat through the fire-resistant glazing whilst reaching the required specifications of fire resistant glazings.

Therefore, according to a first aspect of the invention there is provided a fire-resistant glazing comprising:
at least a first sheet of glazing material comprising a first major face, a second major face and at least one edge face;
at least a second sheet of glazing material comprising a first major face, a second major face and at least one edge face, wherein the first sheet of glazing material and the second sheet of glazing material are arranged in a spaced-apart face-to-face arrangement with the first major faces of the first and second sheet of glazing material facing each other to form a cavity, and wherein the edge faces of the first and second sheets of glazing material are substantially aligned to form a glazing edge;
a primary sealant located between the first sheet of glazing material and the second sheet of glazing material proximate to the glazing edge;
a secondary sealant located between the first sheet of glazing material and the second sheet of glazing material and at least partially between the primary sealant and the glazing edge; and
an intumescent layer located in the cavity between the first sheet of glazing material and the second sheet of glazing material; and wherein
at least one area of the glazing edge comprises a weakened primary sealant portion and/or a weakened secondary sealant portion.

The inventors have discovered that by providing an area in the glazing edge where the primary and/or secondary sealants are weakened, the fire-resistant glazing will vent evolved gas at a lower pressure than in comparable glazings. This prevents the build-up of a gas layer between the intumescent layer and the sheet of glazing material orientated towards the heat source, and thereby allows the intumescent layer to remain substantially in contact with the sheet of glazing material orientated towards the fire, reducing the harmful effects described above.

Surprisingly, such weakening of the fire-resistant glazing edge seal prevents destructive failure of the fire-resistant glazing, while still providing an edge seal of sufficient integrity to prevent the ingress of atmospheric gases external to the glazing. Therefore, the edge seal still retains its essential function of protecting the intumescent layer from premature “aging” that occurs when the intumescent layer is exposed to air.

Furthermore, the inventors have discovered that the area of the glazing edge where the primary and/or secondary is weakened may be controlled. In this manner the glazing designer may ensure that the gas vents in a designated “safe area”, while still ensuring that any evolved gas layer may be vented regardless of its position.

The fire-resistant glazing according to the present invention is suitable for, and may be installed within, a glazing frame. As such, preferably the at least one area wherein the primary and/or secondary sealant is weakened is proximate to a glazing corner.

Consequently, the frame at the corner proximate to the area wherein the primary and/or secondary sealant is weakened is better able to withstand venting pressure than frame edges that are not proximate to corners, which may bow or crack under venting pressure, and which may allow the passage of smoke and/or heat. In addition, the at least one area should preferably not be proximate to glazing hinges, as these may be damaged by venting pressure, thereby allowing the glazing to move which may allow the passage of smoke and/or heat.

As used herein, proximate to a glazing corner is defined as being within 10% of the length of the glazing edge length from the glazing corner. As used herein, proximate to a glazing hinge is defined as being within 10% of the length of the glazing edge length from the glazing hinge.

Preferably, the first sheet of glazing material and/or the second sheet of glazing material comprises glass. Preferably, the first sheet of glazing material and/or the second sheet of glazing material comprises soda-lime silica glass. Glass, in particular soda-line silica glass is a suitable choice as it is readily available and has excellent optical characteristics. Alternatively, the first and/or second sheet of glazing material may comprise glass ceramic, such as alumino-silicate and/or boro-silicate glass.

Preferably, the first sheet of glazing material and/or the second sheet of glazing material comprises strengthened glass. The glass may be strengthened by heat treatment, tempering, toughening, chemical strengthening, by addition of foils or laminations, or a combination. For some uses strengthened glass may be particularly required to meet fire glazing regulations.

Preferably the intumescent layer may comprise an alkali silicate. Alkali silicate intumescent layers are readily available, and examples are described in WO 2008/084083, the contents of which are included herein by reference. An alkali silicate intumescent layer may comprise sodium silicate and/or potassium silicate.

Alternatively, the intumescent layer may comprise an organic hydrogel such as those described in U.S. Pat. No. 4,264,681, the contents of which are included herein by reference.

Preferably the intumescent layer further may comprise an organic material. In addition, preferably the intumescent layer comprises water.

Preferably the primary sealant may comprise a polyisobutylene, such as GD 115 available from Koe-Chemie. The primary sealant preferably prevents ingress of moisture and gas permeation. The primary sealant may be a spacer. Alternatively, the glazing may comprise a separate spacer, which may comprise materials including metals, polymers and/or thermoplastics. Example metals include steel, aluminium and titanium. Example polymers include polyethylene (PE), polypropylene (PP), polytetrafluoroethylene (PTFE), polyvinyl chloride (PVC), acrylonitrile butadiene styrene (ABS), polyurethane (PU), polyisobutylene. The spacer may be a combined primary sealant thermoplastic spacer. A suitable primary sealant spacer comprising polyisobutylene is, for example, Ködimelt Thermoplastic Spacer (TPS) available from Kömmerling Chemische Fabrik GMBH. The primary sealant may comprise a polyisobutylene, such as GD 115 available from Koe-Chemie.

Preferably the secondary sealant may comprise a polysulfide or a derivative, and/or silicone or a derivative, and/or polyurethane or a derivative, and/or a “hotmelt”. Examples of polysulfides include 2-component polysulfides such as GD 116 available from Koe-Chemie. Examples of silicones include 2-component structural glazing silicone such GD 920 available from Koe-Chemie. Examples of polyurethanes include 2-component polyurethanes such as GD 667 NA available from Koe-Chemie. Examples of “Hotmelts” include isomelt and Ködimelt IG available from Koe-Chemie. The secondary sealant preferably connects the glazing sheets and seals the spacer width hermetically. In order for the secondary sealant to accomplish its function, it is preferably present in a thickness of greater than or equal to 1 mm.

Preferably, the at least one area of the glazing edge comprises a weakened primary sealant portion and a weakened secondary sealant portion, and preferably the weakened primary sealant portion and the weakened secondary sealant portion are at least partially co-located.

Such co-location of the weakened portions of the primary sealant and the secondary sealant allows greater control of the venting position, and also significantly lowers the pressure at which a glazing unit may vent compared to a comparable fire-resistant glazing where the weakened primary sealant portion and the weakened secondary sealant portion are not co-located, further reducing the likelihood of gas layer build up.

Preferably, the primary sealant comprises a thermoplastic spacer (TPS), preferably wherein the primary sealant comprises a thermoplastic spacer (TPS) comprising polyisobutylene. Thermoplastic spacers comprising polyisobutylene are readily available and may be weakened as discussed herein.

Preferably, the secondary sealant comprises a polysulfide. Secondary sealants comprising polysulfide may be weakened as discussed herein.

Preferably, the secondary sealant weakened portion comprises a groove parallel to the glazing edge. The inventors have discovered that a secondary sealant comprising a groove parallel to the glazing edge may weaken the secondary sealant in the area of the groove, allowing gases evolved from the intumescent layer to be vented at lower pressures than comparable ungrooved secondary sealants. In some cases the secondary sealant may be provided with a groove along the entire length of a glazing edge, or around the entire glazing periphery.

Alternatively, the secondary seal may be provided with a groove along a portion of a glazing edge. Preferably, where a glazing edge is provided with a grooved secondary sealant, the groove extends along at least 5% of the glazing edge. More preferably, where a glazing edge is provided with a grooved secondary sealant, the groove extends along at least 10% of the glazing edge. The inventors have discovered that a local mechanical weakness, such as notch portion removed from seal that extends along less than 5% of the glazing edge does not provide beneficial effects, because it is difficult to predict where a vent position might be required, as a gas layer may form at multiple positions across the intumescent layer. Therefore, if only local points of mechanical weakness are provided the fire-resistant glazing may not vent the evolved gas layer during exposure to a fire.

The inventors have surprisingly discovered that the secondary sealant may be provided with a groove wherein a significant amount of the secondary sealant material is removed in the grooved area compared to an ungrooved area, without significantly lowering the sealing properties of the secondary sealant. This is thought to be because the intumescent layer of the fire-resistant glazing acts as a weak, large area adhesive that helps to hold the sheets of glazing material together. Therefore, less stress is applied to the secondary sealant in a fire-resistant glazing with an intumescent layer than a comparable insulated glazing unit with a gas filled cavity, and therefore a lower amount of secondary sealant is necessary to maintain the hermetic seal and therefore aging resistance.

Therefore, preferably at least 10% by mass of the secondary sealant material is removed in the grooved area compared to an ungrooved area. More preferably at least 20% by mass of the secondary sealant material is removed in the grooved area compared to an ungrooved area. Even more preferably at least 50% by mass of the secondary sealant material is removed in the grooved area compared to an ungrooved area. Still more preferably at least 60% by mass of the secondary sealant material is removed in the grooved area compared to an ungrooved area.

Where there is no ungrooved area on the entire periphery of the glazing, the calculation is made compared to a notional area of the glazing edge wherein the secondary sealant is applied to be exactly aligned with a line between the two edges of the sheets of glazing material.

However, if too greater amount of the secondary sealant is removed the secondary sealant will fail, reducing the aging performance of the fire-resistant glazing. Therefore, preferably less than 90% by mass of the secondary sealant is removed in the grooved area compared to an ungrooved area. More preferably less than 80% by mass of the secondary sealant is removed in the grooved area compared to an ungrooved area. Even more preferably less than 70% by mass of the secondary sealant is removed in the grooved area compared to an ungrooved area. Where there is no ungrooved area on the entire periphery of the glazing, the calculation is made compared to a notional area of the glazing edge wherein the secondary sealant is applied to be exactly aligned with a line between the two edges of the sheets of glazing material.

According to a second aspect of the present invention there is provided a method of manufacturing a fire-resistant glazing comprising the steps of:
(i) providing a first sheet of glazing material comprising a first major face, a second major face and at least one edge face;
(ii) arranging a primary sealant upon the first major face of the first sheet of glazing material proximate to the at least one edge face of the first sheet of glazing material;
(ii) providing a second sheet of glazing material comprising a first major face, a second major face and at least one edge face;
(iii) forming an assembly by arranging the first and second sheets of glazing material in a spaced-apart face-to-face arrangement with the first major faces of the first and second sheet of glazing material facing each other to form a cavity and wherein the edge faces of the first and second sheets of glazing material are substantially aligned to form a glazing edge; and
(iv) providing an intumescent layer precursor solution in the cavity between the first and second sheets of glazing material;
(v) applying a secondary sealant between the first sheet of glazing material and the second sheet of glazing material and at least partially between the primary sealant and the glazing edge; and
(vi) weakening a portion of the primary sealant and/or a portion of the secondary sealant in at least one area.

Preferably the method comprises weakening both a portion of the primary sealant and a portion of the secondary sealant. Preferably the primary sealant and the secondary sealant are weakened in a co-located area.

Preferably, the step of weakening a portion of the primary sealant and/or the step of weakening a portion of the secondary sealant comprises applying an edge seal deteriorating solution to the primary sealant in the at least one area. The edge seal deteriorating solution is thought to prevent the formation of a gas layer by forming small channels in the edge seal of the fire-resistant glazing, through which gas may vent from the fire-resistant glazing at a lower pressure than the pressure experienced by the glazing during failure. Such small channels are believed to be formed by the interaction between the edge seal and the edge seal deteriorating solution during manufacture.

Preferably, the edge seal deteriorating solution comprises surfactant. Preferably the edge seal deteriorating solution comprises from 0.01% to 10% surfactant. More preferably the edge seal deteriorating solution comprises from 1 to 5% surfactant. Some primary and/or secondary seals are deteriorated effectively by surfactant containing solutions. Where the edge seal deteriorating solution comprises surfactant, preferably the edge seal deteriorating solution comprises water. Where the edge seal deteriorating solution comprises surfactant, the edge seal deteriorating solution may comprise a first surfactant and one or more further surfactants or surfactant mixtures. Preferably, the surfactant is an anionic surfactant. Preferably, the anionic surfactant comprises a sulfate, sulfonate or carboxylate anionic surfactant. Preferably, the sulfate anionic surfactant comprises an alkyl sulfate, such as ammonium lauryl sulfate, sodium lauryl sulfate (sodium dodecyl sulfate, SLS, or SDS), or alkyl-ether sulfates such as sodium laureth sulfate (sodium lauryl ether sulfate or SLES), and sodium myreth sulfate.

Preferably, the edge seal deteriorating solution comprises a solvent. Some primary and/or secondary seals are deteriorated effectively by solvent containing solutions. Preferably the edge seal deteriorating solution comprises from 5 to 80% solvent. More preferably the edge seal deteriorating solution comprises from 10 to 50% solvent. Preferably the solvent has a boiling point of from 50° C. to 100° C. Preferably the solvent is a protic solvent. Preferably the solvent is a polar protic solvent. Preferably the edge seal deteriorating solution comprises a solvent selected from the group comprising: methanol, ethanol, isopropanol, n-butanol, pentanol. Where the edge seal deteriorating solution comprises solvent, the edge seal deteriorating solution may comprise water.

Preferably, the step of applying the edge seal deteriorating solution comprises wiping or brushing the edge seal deteriorating solution onto the primary and/or secondary sealant, and/or the edge seal deteriorating solution is applied using a nozzle, needle, or injection apparatus.

Preferably, the edge seal deteriorating solution is applied onto a surface of the primary sealant orientated away from the cavity and/or the edge seal deteriorating solution is applied onto a surface of the primary sealant orientated towards the cavity.

Where the edge seal deteriorating solution is applied onto a surface of the primary sealant to be orientated towards the glazing environment, this is carried out by wiping or brushing the edge seal deteriorating solution either before or after forming the assembly.

Where the edge seal deteriorating solution is applied onto a surface of the primary sealant to be orientated towards the glazing interior after forming the assembly, this is preferably carried out using a nozzle, needle, or injection apparatus.

Preferably, the step of weakening a portion of the secondary sealant comprises forming a groove parallel to the glazing edge in the surface of the secondary sealant. Preferably, the secondary sealant is removed using a knife, scraper or other implement.

According to a third aspect of the present invention, there is provided the use of a fire-resistant glazing according to, or manufactured by, any preceding aspect in a fire-resistant glazing assembly.

Such fire-resistant glazing assemblies may be ready for installation in a building or vehicle, or may require further processing.

Current fire regulations classify the fire resistance of glazing by the measurement of the minimum time for which the glazing maintains: (i) its structural integrity (termed E); (ii) its structural integrity and radiation reduction within specified limits (termed EW); and (iii) its structural integrity and insulation within specified limits (termed El) when exposed to a fire. Standard tests to determine the classification of the fire resistance of a glazing are known and typically involve exposing the one side of the glazing unit (the “fire side” or “hot side”) to a fire and monitoring the integrity of the glazing, and/or temperature levels on the opposing side of the glazing (the “cold side”) over time.

Preferably, the fire-resistant glazing assembly according to the present invention conforms to at least E 30 standard, preferably at least E 60 standard, more preferably at least E 120 standard, measured according to DIN EN 13501-2.

Preferably, the fire-resistant glazing assembly according to the present invention conforms to at least EI 15 standard, preferably at least EI 30 standard, more preferably at least EI 60 standard, measured according to DIN EN 13501-2.

Preferably, the fire-resistant glazing assembly according to the present invention conforms to at least EW 30 standard, preferably at least EW 60, more preferably at least EW 90, measured according to DIN EN 13501-2.

For maritime glazings, glazings may be classified using A and B standards according to IMO A.754(18).

Preferably, the fire-resistant glazing assembly according to the present invention conforms to at least A0 standard, preferably at least A15, more preferably at least A30, yet more preferably A60 according IMO A.754(18).

Preferably, the fire-resistant glazing assembly according to the present invention conforms to at least B0 standard, preferably at least B15, according to IMO A.754(18).

For trains and transportation glazings may be classified using A1 and A2 standards according to EN 45545 part 3.

Preferably, the fire-resistant glazing assembly according to the present invention conforms to at least A1-15 standard, preferably at least A1-30 standard, according to EN 45545 part 3.

Preferably, the fire-resistant glazing assembly according to the present invention conforms to at least A2-15 standard, preferably at least A2-30 standard, according to EN 45545 part 3.

It will readily be appreciated that all features described in relation to the first aspect of the present invention also apply in respect of the second and third aspects of the present invention, and vice versa.

Embodiments of the present invention will now be described by way of example only with reference to the following accompanying drawings, in which:

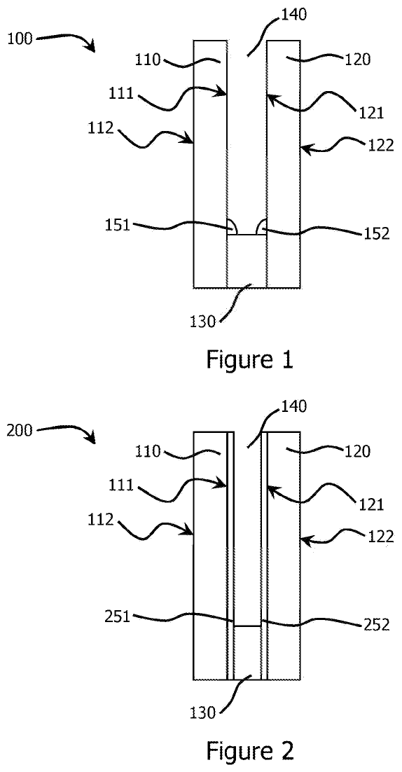

FIG. 1 depicts a schematic cross-sectional view of an alternative assembly produced during a method of manufacturing a fire-resistant glazing according to the present invention;

FIG. 2 depicts schematic cross-sectional view of an assembly produced during a method of manufacturing a fire-resistant glazing according to the present invention;

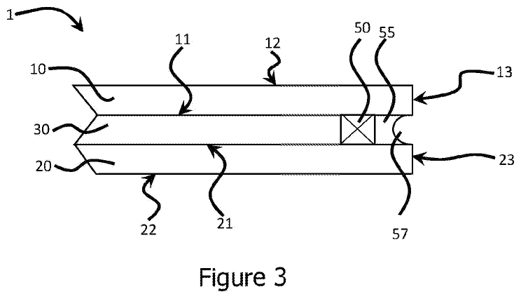

FIG. 3 illustrates a schematic cross-sectional view of a fire-resistant glazing according to the present invention;

In FIG. 1 an assembly 100 comprises a first sheet of glazing material 110 comprising a first major face 111 and a second major face 112, and a second sheet of glazing material 120 comprising a first major face 121 and a second major face 122. The second sheet of glazing material 120 is in a spaced-apart face-to-face arrangement with the first sheet of glazing material 110, wherein the first major face 111 of the first sheet of glazing material 110 faces the first major face 121 of the second sheet of glazing material 120. The fire-resistant glazing 100 further comprises an edge seal 130 between the first sheet of glazing material 110 and the second sheet of glazing material 120, thereby forming a cavity 140 between the sheets of glazing material 110, 120 and the edge seal 130. In this depiction, an edge seal deteriorating solution has been inserted into the cavity 140, and has been applied to the edge seal 130 as beads 151, 152. The application may be carried out by, for example, an injection apparatus. Alternatively or in addition, the solution may be run down the first faces of the first and second glazing panes 111, 121 as aided by gravity.

In FIG. 2 another assembly 200 is depicted, in which like features with FIG. 1 are indicated with like reference numerals. The assembly 200 differs from the assembly of the first embodiment in that an edge seal deteriorating solution has been applied to the sheets of glazing material 110, 120 as layers 251, 252, prior to application of spacers and/or primary sealant and/or secondary sealant. In this case, the step of weakening a portion of the primary sealant and/or a portion of the secondary sealant in at least one area occurs after assembly, where the primary sealant and/or secondary sealant comes into contact with the edge seal deteriorating solution that has been applied to the sheets of glazing material. Edge seal deteriorating solution may be applied to the sheets of glazing material as layers by the use of a glass washing machine.

In FIG. 3 there is provided a fire-resistant glazing 1 which comprises a first sheet of glazing material 10 comprising a first major face 11, a second major face 12 and an edge face 13; and a second sheet of glazing material 20 comprising a first major face 21, a second major face 22 and an edge face 23. The second sheet of glazing material 20 is in a spaced-apart face-to-face arrangement with the first sheet of glazing material 10 and the first major face 11 of the first sheet of glazing material 10 faces the first major face 21 of the second sheet of glazing material 20 to form a cavity.

The fire-resistant glazing 1 further comprises an intumescent layer 30 located in the cavity between the first sheet of glazing material 10 and the second sheet of glazing material 20.

A spacer 50, is provided between the sheets of glazing material 10, 20. The spacer is conventionally provided to maintain the distance between the first and second sheets of glazing material 10, 20, and spacers are often provided around substantially the entire periphery of the glazing. The spacer may be a thermoplastic spacer comprising a primary sealant. The primary sealant may have been weakened by the application of an edge seal deteriorating solution.

A secondary sealant 55 is provided between the sheets of glazing material. The secondary sealant 55 is conventionally applied to reduce the ingress of air, which may cause the intumescent layer 30 to become hazy or discoloured and thereby reduce visibility through the fire-resistant glazing 1 over time. In addition, the secondary sealant 55 may also prevent egress of the intumescent layer from the fire resistant glazing prior to a fire incident.

The fire-resistant glazing 1 as depicted in FIG. 3 includes a groove 57 formed in the secondary sealant 55. The groove 57 is formed such that it extends along the glazing edge between the edges of the first and second sheets of glazing material 13, 23. The groove 57 may be formed by partial removal of the secondary sealant 55 using a tool either before, during or after curing the secondary sealant 55. Depending on the profile of the tool used to create the groove 57, the profile of the secondary sealant 55 may be convex, concave, or a combination thereof following curing.

For example, as depicted in in FIG. 3, the secondary sealant 55 may be provided with a concave profile. Alternatively, where the secondary sealant 55 may be provided with a convex profile. The groove 57 may be formed by using a tool following application of the secondary sealant 55, or by using a mask to prevent the secondary sealant 55 completely filling the void between the first and second sheets of glazing material 10, 20 during application.

Where the glazing material comprises multiple sheets of glazing material arranged in a repeating pattern separated by multiple cavities and/or intumescent layers, preferably one or more and more preferably each secondary sealant associated with an intumescent layer may be provided with a grooved portion. An additional cavity may comprise intumescent layers, insulating gases such as argon, or vacuum. Where more than one additional cavity is provided, the additional cavities may comprise the same contents (intumescent layers, insulating gases, vacuum), or different contents.

In a further modification of each of the embodiments described above, one or more of the first major faces of each sheet of glazing material may comprise an enamel coating. The enamel coating may extend around the periphery of one or more sheets of glazing material in the fire resistant glazing. Enamel coatings may provide an aesthetically pleasing edge region to the fire-resistant glazing. The enamel coating may also protect the primary and/or secondary seals from degradation by UV light. When applied, the enamel coating may extend from between 15 mm to 20 mm from the edge of the sheet of glazing material.

In addition, whilst each edge face 13, 23, are illustrated substantially aligned, alternatively, the edge face of one or more sheets of glazing may protrude out of alignment with the edge face of a second or further sheet of glazing material. That is, the sheets of glazing material may be staggered. That is, each embodiment may be provided with aligned sheets of glazing material, or staggered sheets of glazing material. Nevertheless, the skilled person will readily appreciate that such an arrangement results in a glazing edge that may be offered to the frame during installation.

Whilst in the embodiments described above only two sheets of glazing material are depicted, the embodiments of the present invention described also cover embodiments of fire resistant glazings with three, four, or more sheets of glazing material.

In addition, the embodiments described above may form a part of or a whole fire-resistant glazing. That is, the embodiments may be repeated, or combined together, to form fire-resistant glazings with multiple intumescent layers. This arrangement is particularly beneficial when fire-resistant glazings are required which provide a longer fire-resistance time.

The inventive glazings according to the present invention may be provided with an edge tape for encapsulating the edge of the glazing to prevent water ingress. Such edge tapes should be sufficiently thin and flexible to conform to the profile of the glazing edge and/or the profile of the secondary seal, to prevent trapping air within the glazing edge region.

Experimental embodiments of the present invention will now be described by way of example.

Fire resistant glazings according to the present invention were prepared with two sheets of 6 mm toughened float glass arranged with 6 mm of intumescent material located therebetween. The glazing included a thermoplastic spacer and a secondary sealant of polysulfide. A portion of the secondary sealant was removed by tooling to form a groove parallel to the glazing edge.

Testing of fire-glazing examples was carried out in a standard frame measuring 1015 mm wide by 2010 mm high, by exposing the fire-resistant glazings to a gas burner heat source until failure of the fire-resistant glazings according to safety standard Class EI, in accordance with EN 138501-1, incorporated herein by reference.

Glazings were also submitted to an aging test, wherein the glazings were exposed to a dry atmosphere with or without heat to simulate the effect of aging upon the glazing.

Comparative glazing example CE 1 was prepared without an edge seal deteriorating solution. During fire testing, the intumescent interlayer of CE 1 foamed in an inhomogeneous manner and the glazing unit failed the test due to unacceptable transmission of heat through the glazing. In some cases, such inhomogeneous foaming may cause cracking of a toughened glass sheet orientated away from the fire.

For comparative glazing examples CE2 and examples 1 to 3 a solution of edge seal deteriorating solution was produced by mixing 3 ml of a solution of 3% sulfate anionic surfactant in water with 0.5 ml of isopropanol resulting in an aqueous solution comprising 2.6% surfactant and 14.3% isopropanol.

Comparative glazing example CE 2 was prepared using an edge seal deteriorating solution which was mixed into the interlayer. CE 2 did not pass the fire test.

To form the examples according to the present invention the same process was followed as for CE 1, except that, prior to providing the solution of intumescent layer precursor solution, an edge seal deteriorating solution was applied to the interior surface of the thermoplastic spacer primary sealant.

Glazing example 1 was conducted using an edge seal deteriorating solution wiped onto the major surface of the glass sheets.

Glazing example 2 was conducted using an edge seal deteriorating solution wiped onto the edge region of the glass sheets, where the edge seal will adhere

Glazing example 3 was conducted using an edge seal deteriorating solution inserted into the assembly, and applied manually to the edge seal using a syringe and needle apparatus.

| | Examples | | | | |
|---|---|---|---|---|---|
| | CE 1 | CE 2 | 1 | 2 | 3 |
| Application Method | N/A | Interlayer | Wiped | Wiped | Injection |
| Application region | N/A | Interlayer | Whole surface | Edge region | Interface |
| Fire test result | Fail | Fail | Pass | Pass | Pass |
| Aging Test Result | Pass | Pass | Pass | Pass | Pass |

Experiments were undertaken to assess the effect of different edge seal deteriorating solutions. Both Examples 1 and 6 were produced by injecting edge seal deteriorating solution, but Example 6 did not contain surfactant and was instead 100% isopropanol. While Example 6 passed the fire test, large distortions were seen during the test, which indicates that this solution may be unsuitable in some cases.

The comparative examples and examples were submitted to an aging test. Example 6, produced by injecting 100% isopropanol, failed the aging test. This indicates that this edge deteriorating solution deteriorated the edge seal to the extent that it was no longer able to perform the essential function of protecting the intumescent layer from the atmosphere. Each of the other comparative examples and examples according to the invention passed the aging test.

Examples

| | 3 | 4 | 5 | 6 |
|---|---|---|---|---|
| Surfactant | 2.58% | 2.58% | 5% | 0 |
| concentration % | | | | |
| Isopropanol | 14% | 50% | 14% | 100% |
| concentration % | | | | |
| Solution volume (ml/m²) | 0.33 | 0.33 | 0.33 | 1.5 |
| Fire test result | Pass | Pass | Pass | Pass |
| Aging Test Result | Pass | Pass | Pass | Fail |

The at least one area where the glazing edge comprises a weakened primary sealant portion and/or a weakened secondary sealant portion may be indicated upon the glazing for the benefit of the end user, such that they may orientate the glazing in the frame in the safest manner. For example, the indication may be in the form of an enamel coating and/or a painted coating.

1.-25. (canceled)

26. A fire-resistant glazing comprising:
a first sheet of glazing material comprising a first major face, a second major face and at least one edge face;
a second sheet of glazing material comprising a first major face, a second major face and at least one edge face, wherein the first sheet of glazing material and the second sheet of glazing material are arranged in a spaced-apart face-to-face arrangement with the first major faces of the first and second sheet of glazing material facing each other to form a cavity, and wherein the edge faces of the first and second sheets of glazing material are substantially aligned to form a glazing edge;
a primary sealant located between the first sheet of glazing material and the second sheet of glazing material proximate to the glazing edge;
a secondary sealant located between the first sheet of glazing material and the second sheet of glazing material and at least partially between the primary sealant and the glazing edge; and
an intumescent layer located in the cavity between the first sheet of glazing material and the second sheet of glazing material; and wherein
at least one area of the glazing edge comprises a weakened primary sealant portion and/or a weakened secondary sealant portion.

27. A fire-resistant glazing according to claim 26, wherein the at least one area of the glazing edge comprises a weakened primary sealant portion and a weakened secondary sealant portion.

28. A fire-resistant glazing according to claim 27, wherein the weakened primary sealant portion and the weakened secondary sealant portion are at least partially co-located.

29. A fire-resistant glazing according to claim 26, wherein the primary sealant comprises a thermoplastic spacer (TPS).

30. A fire-resistant glazing according to claim 29, wherein the thermoplastic spacer (TPS) comprises polyisobutylene.

31. A fire-resistant glazing according to claim 26, wherein the secondary sealant comprises polysulfide.

32. A fire-resistant glazing according to claim 26, wherein the secondary sealant weakened portion comprises a groove parallel to the glazing edge, wherein the groove extends along at least 5% of the glazing edge, preferably along at least 10% of the glazing edge.

33. A fire-resistant glazing according to claim 26, wherein the intumescent layer comprises alkali silicate.

34. A fire-resistant glazing according to claim 26, wherein the at least one area is located proximate to a glazing corner.

35. A fire-resistant glazing according to claim 26, wherein the at least one area is not located proximate to a glazing hinge.

36. A method of manufacturing a fire-resistant glazing comprising the steps of:
(i) providing a first sheet of glazing material comprising a first major face, a second major face and at least one edge face;
(ii) arranging a primary sealant upon the first major face of the first sheet of glazing material proximate to the at least one edge face of the first sheet of glazing material;
(ii) providing a second sheet of glazing material comprising a first major face, a second major face and at least one edge face;
(iii) forming an assembly by arranging the first and second sheets of glazing material in a spaced-apart face-to-face arrangement with the first major faces of the first and second sheet of glazing material facing each other to form a cavity and wherein the edge faces of the first and second sheets of glazing material are substantially aligned to form a glazing edge; and
(iv) providing an intumescent layer precursor solution in the cavity between the first and second sheets of glazing material;
(v) applying a secondary sealant between the first sheet of glazing material and the second sheet of glazing material and at least partially between the primary sealant and the glazing edge; and
(vi) weakening a portion of the primary sealant and/or a portion of the secondary sealant in at least one area.

37. A method according to claim 36, comprising a step of weakening a portion of the primary sealant and a step of weakening a portion of the secondary sealant in a co-located area.

38. A method according to claim 36, wherein the step of weakening a portion of the primary sealant and/or the step of weakening a portion of the secondary sealant comprises applying an edge seal deteriorating solution to the primary sealant in the at least one area.

39. A method according to claim 38, wherein the edge seal deteriorating solution comprises surfactant, preferably the edge seal deteriorating solution comprises from 0.01% to 10% surfactant, more preferably the edge seal deteriorating solution comprises from 1 to 5% surfactant.

40. A method according to claim 38, wherein the edge seal deteriorating solution comprises a solvent, preferably a polar protic solvent selected from the group consisting of methanol, ethanol, isopropanol, n-butanol and pentanol.

41. A method according to claim 38, wherein edge seal deteriorating solution is applied by wiping or brushing, and/or wherein the edge seal deteriorating solution is applied using a nozzle, needle, or injection apparatus.

42. A method according to claim 38, wherein the edge seal deteriorating solution is applied onto a surface of the primary sealant orientated away from the cavity, and/or wherein the edge seal deteriorating solution is applied onto a surface of the primary sealant orientated towards the cavity.

43. A method according to claim 36, wherein the step of weakening a portion of the secondary sealant comprises forming a groove parallel to the glazing edge in the surface of the secondary sealant.

44. A method according to claim 43, wherein the step of forming a groove parallel to the glazing edge in the surface of the secondary sealant comprises tooling the secondary sealant before, during or after curing.

45. A fire-resistant glazing assembly comprising a fire-resistant glazing according to claim 26.
